(19) United States
(12) Patent Application Publication
(10) Pub. No.: US 2020/0115134 A1
(43) Pub. Date: Apr. 16, 2020

(54) ASSEMBLY COMPRISING A SADDLE AND AN UNDERSADDLE COMPARTMENT FOR A MOTORCYCLE, PROVIDED WITH AN OBJECT BLOCKING SYSTEM FOR BLOCKING AN OBJECT IN THE UNDERSADDLE COMPARTMENT

(71) Applicant: PIAGGIO & C. S.p.A., Pontedera, Pisa (IT)

(72) Inventor: Mario Donato SANTUCCI, Pontedera, Pisa (IT)

(73) Assignee: PIAGGIO & C. S.p.A., Pontedera, Pisa (IT)

(21) Appl. No.: 16/482,192

(22) PCT Filed: Jan. 26, 2018
(86) PCT No.: PCT/IB2018/050487

§ 371 Date: Jul. 30, 2019

(30) Foreign Application Priority Data
Jan. 31, 2017 (IT) 102017000010188

(51) Int. Cl. B65D 81/107; B62K 19/46

(52) U.S. Cl. CPC B65D 81/1075; B62J 1/12; B62K 19/46

(57) ABSTRACT

An assembly includes a saddle and an undersaddle compartment for a motorcycle. The undersaddle compartment includes a container body having an access opening and a bottom joined to a side wall. The saddle has a first face shaped for the seat of a driver and an opposite second face. The saddle connects to the undersaddle compartment and allows access to the undersaddle compartment and to the container body in an open configuration. An inflatable member fastened to the second face has a resting configuration, in which the inflatable member is deflated and allows an object to be inserted into the container body; and an expanded configuration to block the object in the container body against the side wall, bottom and/or the second face. An inflation device connects to and expands the inflatable member. A release device connects to the inflatable member to deflate the inflatable member.

The present invention in general relates to the field of motorcycles and more specifically, to an assembly comprising a saddle and an undersaddle compartment for a motorcycle as defined in the preamble of claim 1.

On certain types of motorcycles, in particular but not exhaustively two- or several-wheel motor scooters, the application is known of storage compartments or helmet compartments obtained both under the saddle and in the form of a top box applied to or integrated in the rear part of the vehicle.

In the case of undersaddle compartment, the use of openable saddles for allowing access to the compartment itself, is established. Traditional saddles for motorcycles usually are made from a rigid support called a “saddle plate” which carries a padded part filled with polyurethane foam, and are provided with support and coupling means to the frame. Such saddles typically are connected to the frame so as to take on an open configuration which allows access to the undersaddle compartment, and a closed configuration in which the saddle closes the undersaddle compartment at the top, thus preventing access to such a compartment.

The undersaddle compartment normally is defined by a rigid body which serves as container with a closed bottom which, as described above, is suitable for being closed at the top by the saddle, which serves as lid of the undersaddle compartment by means of the saddle plate.

One drawback of motorcycles of the known art is due to the fact that when the undersaddle compartment is for example, used to transport one or two helmets (driver and passenger), in certain cases due to the sizes and volume thereof, they could undergo even minimum movements in the undersaddle compartment during the use of the motorcycle. To the extent the sturdiness of the helmets themselves prevents the helmets from being seriously damaged, they may damage the paint or surface finish with knocks or rubbing, in addition to inducing noise.

In addition, it has to be noted that the undersaddle compartment may also be used for transporting other larger or smaller, more or less fragile objects, other than helmets. This in particular manner when the motorcycle is being operated and the helmet is worn by the driver. To this end, another drawback of motorcycles of the known art is due to the fact that when the undersaddle compartment is used to transport various-sized objects other than helmets, they are retained with difficulty by the walls of the compartment and accordingly, following for example jolts to which the motorcycle is subjected during operation, in addition to knocking against the side wall of the compartment or the lower wall of the saddle and being damaged, they may bounce and generate noise.

It is an object of the present description to propose an assembly comprising a saddle and an undersaddle compartment for a motorcycle which allows the above drawbacks with reference to motorcycles of the known art to be resolved or at least partly obviated.

This and other objects are achieved by means of an assembly comprising a saddle and an undersaddle compartment for a motorcycle as defined in claim 1 in the most general embodiment thereof, and in the claims dependent thereon in certain particular embodiments thereof.

A motorcycle as defined in claim 10 is also the object of the present invention.

The invention will be better understood from the following detailed description of embodiments thereof, given by way of example and therefore non-limiting in relation to the accompanying drawings, in which:

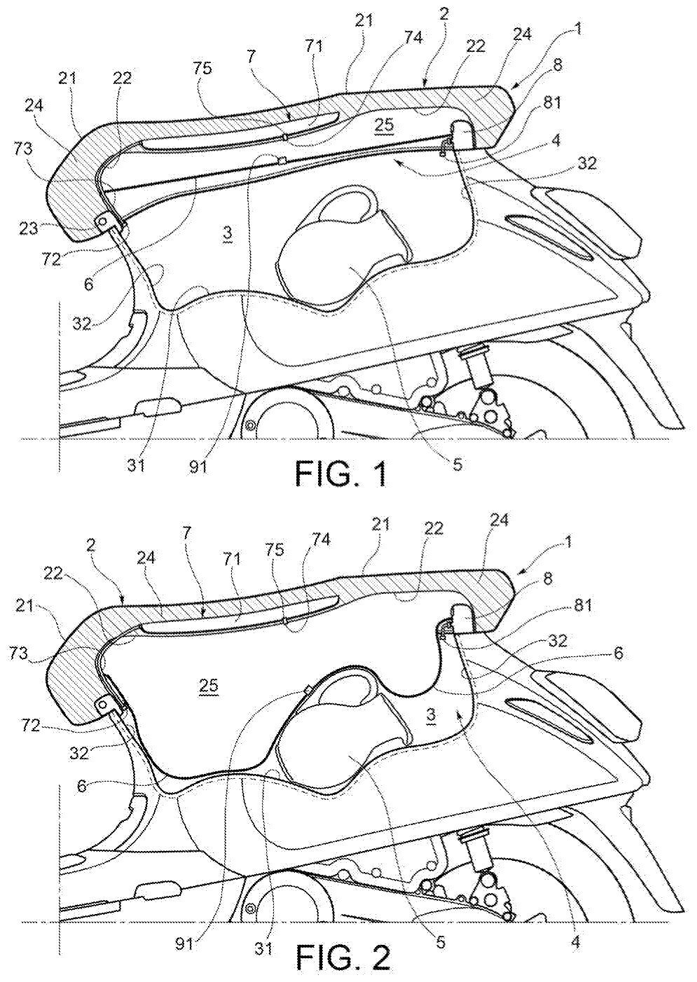

FIG. 1 is a side, partial cross section plan view depicting part of a motorcycle according to a first embodiment, there being depicted in such a drawing the saddle of the motorcycle in a closed configuration and an object blocking system according to a first embodiment, for blocking an object in the undersaddle compartment of the motorcycle, such an object blocking system being depicted in a resting configuration;

FIG. 2 is a side plan view similar to FIG. 1, in which the object blocking system in FIG. 1 is depicted in an expanded configuration for blocking an object accommodated in the undersaddle compartment;

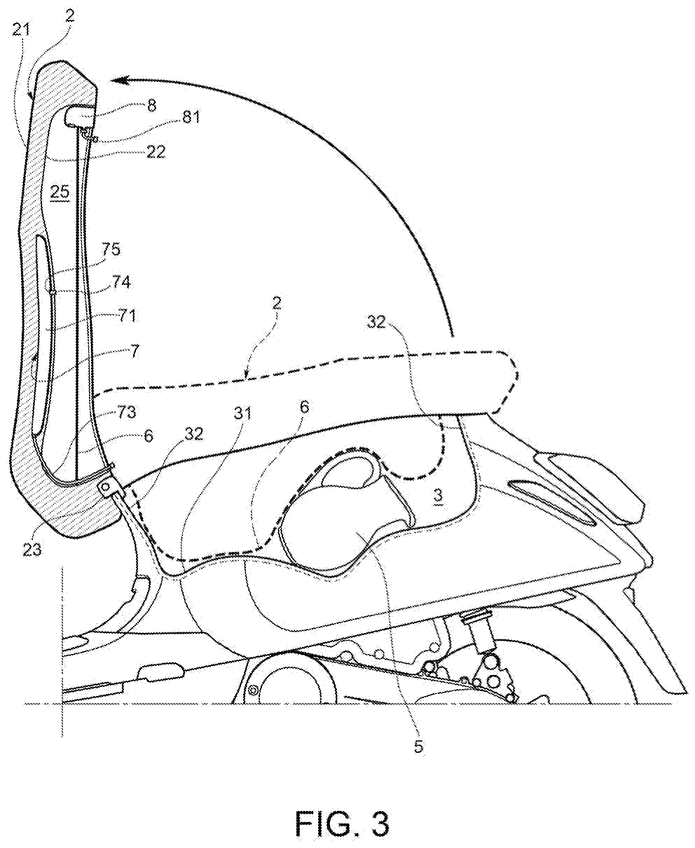

FIG. 3 is a side, partial cross section plan view partially showing the motorcycle in FIG. 1, in which the solid lines depict the saddle in an open configuration and the object blocking system in the resting configuration, while the dotted lines depict the saddle in the closed configuration and the object blocking system in the expanded configuration while it blocks the object contained in the undersaddle compartment;

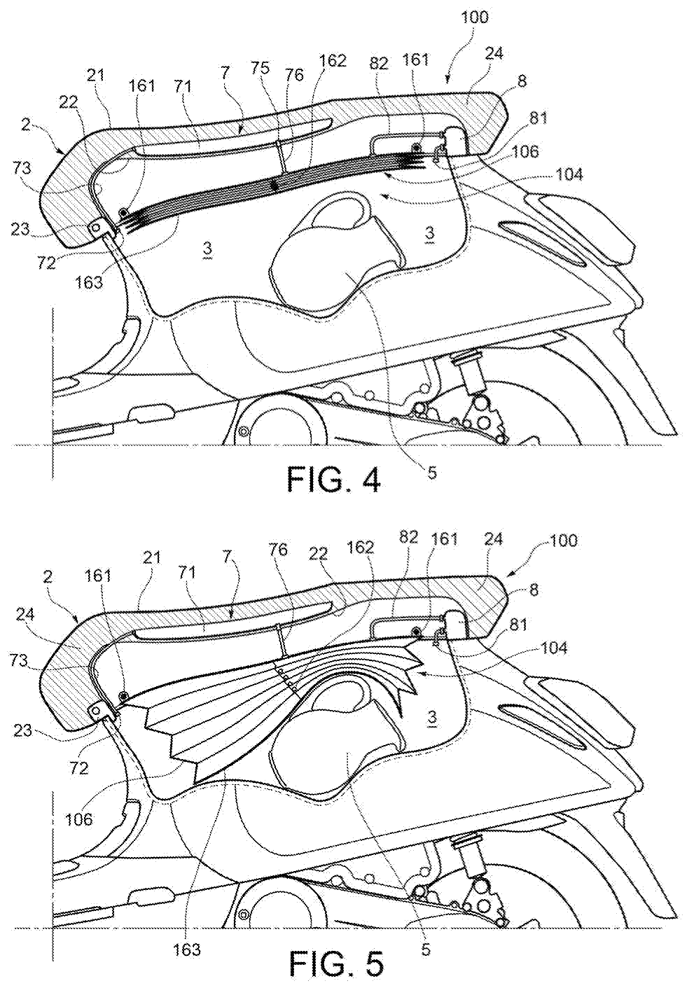

FIG. 4 is a side, partial cross section plan view depicting part of a motorcycle according to a second embodiment, there being depicted in such a drawing the saddle of the motorcycle in a closed configuration and an object blocking system according to a second embodiment, for blocking an object in the undersaddle compartment of the motorcycle, such an object blocking system being depicted in a resting configuration;

FIG. 5 is a side plan view similar to FIG. 4, in which the object blocking system in FIG. 4 is depicted in an expanded configuration in which such a system blocks an object accommodated in the undersaddle compartment of the motorcycle;

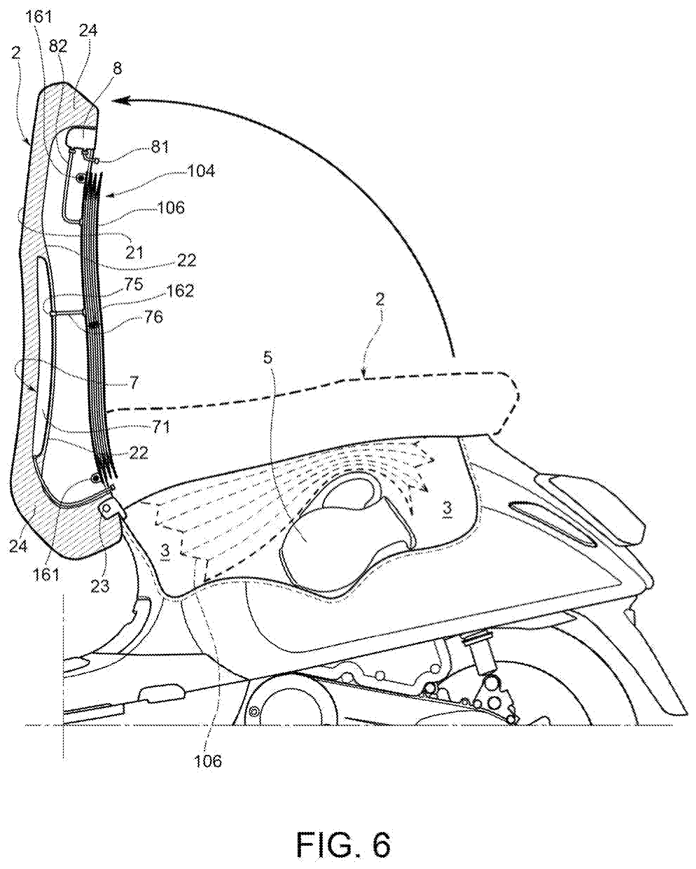

FIG. 6 is a side, partial cross sectional plan view showing part of the motorcycle in FIG. 4, in which the solid lines depict the saddle in an open configuration and the object blocking system in the resting configuration, while the dotted lines depict the saddle in the closed configuration and the object blocking system in the expanded configuration;

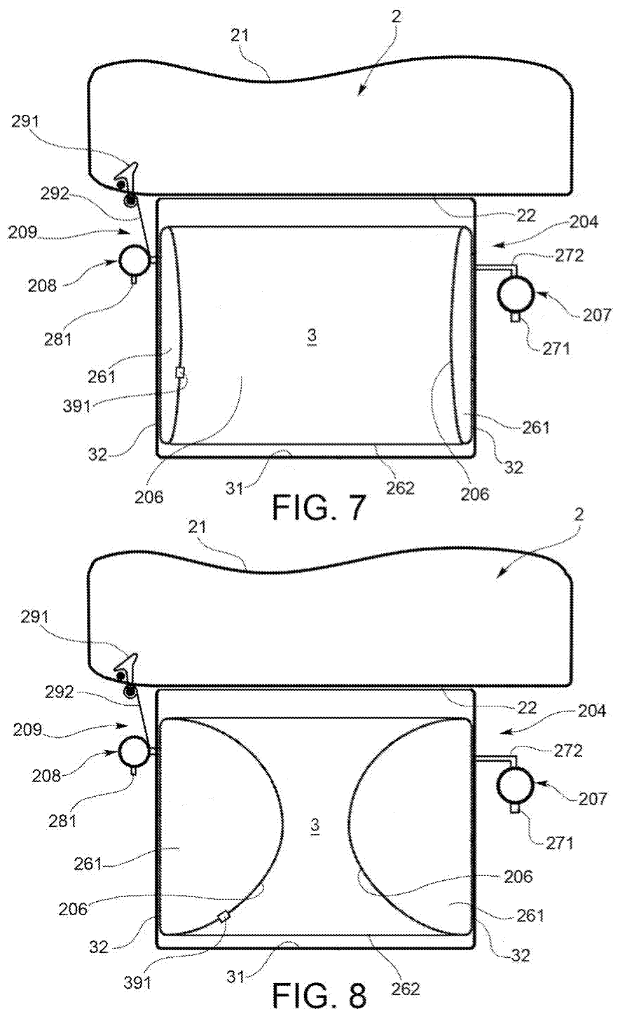

FIG. 7 is a diagrammatic side, cross section view of an assembly comprising a saddle and an undersaddle compartment for a motorcycle according to a third embodiment, such an assembly being provided with an object blocking system according to a third, currently preferred embodiment for blocking an object in the undersaddle compartment, such an object blocking system is depicted in a respective resting configuration;

FIG. 8 is a side view similar to FIG. 7, in which the object blocking system in FIG. 7 is depicted in an expanded configuration in which such a system is suitable for blocking an object accommodated in the undersaddle compartment, there being no object to be blocked in the undersaddle compartment in FIG. 8; and

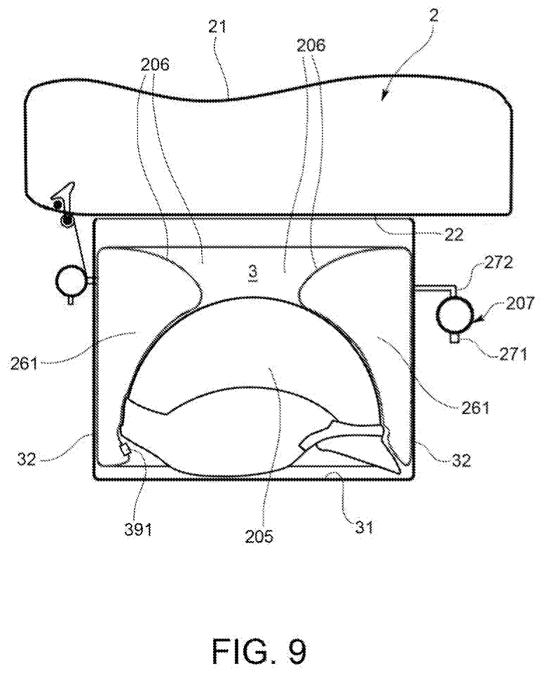

FIG. 9 is a side view similar to FIG. 8, in which the object blocking system is depicted in an expanded configuration in which it blocks an object in the undersaddle compartment.

Equal or similar elements are indicated with the same numerals in the accompanying figures.

It is worth noting that the terms “inner” and “outer” in the present description refer to the middle of the undersaddle compartment.

It is also worth noting that the terms “top”, “bottom”, “upper”, “lower”, “vertical”, “horizontal” in the present description are meant in reference to a motorcycle or an assembly comprising a saddle and an undersaddle compartment in a normal condition of use in which the motorcycle or the assembly is not tilted and the saddle is in the closed configuration in which it closes the undersaddle compartment.

With reference to FIGS. 1 to 3, a motorcycle according to a first embodiment is partly shown, which is indicated as a whole with numeral 1. According to a preferred embodiment, motorcycle 1 is a moto scooter 1. However, it is worth noting that the teachings of the present description generally are applicable to two- or three-wheel motorcycles provided with a saddle and an undersaddle compartment. It is also worth noting that for the purposes of the present description, the term “motorcycle” generally is meant in a manner to include for example, and not limited to, mopeds, motor scooters, etc.

Motorcycle 1 comprises an assembly 2, 3, 4 comprising a saddle 2 and an undersaddle compartment 3. In a manner known in itself, the undersaddle compartment 3 comprises a container body 31, 32. According to a preferred embodiment, the container body 31, 32 is a rigid container body 31, 32. Body 31, 32 preferably has a closed or substantially closed bottom. Preferably, the container body 31, 32 comprises an access opening 33, a bottom wall 31 and a side wall 32 joined perimetrally at the bottom wall 31. Saddle 2 comprises a first face 21 of saddle shaped for the seat of a driver of motorcycle 1 and an opposite second face 22 of saddle suitable for facing towards the undersaddle compartment 3. According to a preferred embodiment, face 22 is a face of the saddle plate, i.e. a face of the rigid part of saddle 2 adapted to provide the support for the driver. In particular, face 22 preferably is the lower end face of the saddle plate of saddle 2. Saddle 2 is operatively connected to the undersaddle compartment 3, preferably by means of a hinge 23, so as to take on an open configuration (FIG. 3) in which saddle 2 allows access to the undersaddle compartment 3 and to the container body 31, 32 by means of the access opening 33, and a closed configuration in which saddle 2 closes the undersaddle compartment 3, thus preventing access to such a compartment 3 and to the container body 31, 32. In other words, in a manner in itself known, in the closed configuration, saddle 2 serves as lid which closes the undersaddle compartment 3 at the top. Again with reference to FIGS. 1 to 3, advantageously assembly 2, 3, 4 comprises an object blocking system 4 according to a first preferred embodiment. The object blocking system 4 allows an object 5 accommodated in the container body 31, 32 of the undersaddle compartment 3 to be blocked. In the example, object 5 consists of—not exhaustively—a jug 5. In particular, the object blocking system 4 comprises an inflatable member 6 or expandable member 6 fastened to the second face 22 of saddle. The inflatable member 6 is a blocking member provided to block object 5 accommodated in the container body 31, 32. Again with reference to FIGS. 1 to 3, according to a preferred embodiment, the inflatable member 6 or expandable member 6 comprises an elastically deformable membrane 6 fastened to the second face 22 of saddle so as to ensure the gas tightness between said membrane 6 and said second face 22 of saddle. The inflatable member 6 or expandable member 6 is suitable for taking on a resting configuration (FIG. 1 or depiction with solid line in FIG. 3), in which the inflatable member 6 is deflated and allows object 5 to be inserted into the container body 31, 32 by means of the access opening 33, and an expanded configuration (FIG. 2 or depiction with dotted lines in FIG. 3), in which the inflatable member 6 is expanded with respect to the resting configuration, respectively. According to a preferred embodiment (not depicted), the inflatable member 6 is adherent or substantially adherent to the second face 22 of saddle 2 in the resting configuration. As can be noted for example in FIG. 2, the inflatable member 6 is extended in the undersaddle compartment 3 and is suitable for blocking object 5 accommodated in the undersaddle compartment 3 in the expanded configuration and when saddle 2 takes on the closed configuration. As can be noted in FIG. 2, object 5 is blocked between the inflatable member 6 and the bottom wall 31 of the rigid body 31, 32. In particular, the inflatable member 6 is suitable for blocking object 5 against the bottom wall 31 in the expanded configuration and when saddle 2 takes on the closed configuration. According to a preferred embodiment, a pressure control valve 91, in itself known, may be associated with the inflatable member 6. It is worth noting according to an alternative embodiment not depicted, that the elastic membrane 6 could be replaced for example, by an inflatable elastic balloon, for example made of rubber, which may be fastened to saddle 2. Preferably, such an elastic balloon is fastened to face 22 below the saddle plate. Such an inflatable elastic balloon is shaped for example, like an expandable bag of the type used like a rubber ice bag but it has much more yielding elastic features with respect to a common ice bag. Such a balloon may have for example, a discoidal shape in the resting configuration (flat and circular) and is suitable for being inflated so as to extend into compartment 3 in the expanded configuration to then take on the resting configuration again once deflated. The latter solution with inflatable elastic balloon allows an easier tightness to the pressure of the object blocking system and an increased assembly affordability with respect to the solution which provides the elastic membrane 6.

The object blocking system 4 comprises an inflation device 7 operatively connected to the inflatable member 6. The inflation device 7 is suitable for expanding the inflatable member 6 from the resting configuration to the expanded configuration. According to a preferred embodiment, the inflation device 7 comprises an air pump 7. Preferably, the air pump 7 comprises an air chamber 71. The air chamber 71 is suitable for communicating with the undersaddle compartment 3 or with the outside of motorcycle 1 or of the undersaddle compartment 3 to suck air inside said air chamber 71. Moreover, the air chamber 71 is suitable for communicating with the inflatable member 6 to allow the inflation of such a member 6. For example, the air pump 7 may comprise a suction opening 72 or a suction duct 72, 73 arranged to suck air from the undersaddle compartment 3, or from the outside of motorcycle 1 or of the undersaddle compartment 3, and a delivery opening 74 arranged to emit air into a space 25 comprised between membrane 6 and the second face 22 of saddle. Preferably, the delivery opening 74 is associated with a check valve 75 of pump 7. According to a preferred embodiment, the air pump 7 is operable by repeatedly pressing so as to compress the air chamber 71. According to a preferred embodiment, the air chamber 71 is accommodated in saddle 2 and more preferably, is formed in a padding 24 of saddle 2. In this case, by repeatedly pressing on the first face 21 of saddle 2, the air chamber 71 is compressed for the inflation of the inflatable member 6. Such an operation of pump 7 may be carried out by example both manually, for example when the motorcycle is stopped, and during the operation of motorcycle 1 by means of jolts of the driver of the motorcycle sitting in saddle 2. Conveniently, the fact of providing an air pump integrated in the padding of saddle 2 allows an on-board electric energy not to be used and an automatic inflation of the inflatable member 6 to be carried out. It is worth noting that according to further alternative embodiments (not depicted), in place of an air pump obtained in padding 24 of saddle 2, the inflation device 7 could provide for example and not exhaustively, an air pump of mechanical type manually operable by means of an operating handle accessible from the outside of motorcycle 1 and operatively connected to the inflatable member 6. Alternatively, the inflation device 7 may comprise an electric pump fastened to saddle 2 or to another part of motorcycle 1, which preferably can be controlled by means of control elements provided for example, on the dashboard of motorcycle 1.

Again with reference to FIGS. 1 to 3, the object blocking system 4 comprises a release device 8 operatively connected to the inflatable member 6. The release device 8 is suitable for deflating the inflatable member 6 to bring it from the expanded configuration (e.g. FIG. 2) to the resting configuration (e.g. FIG. 1). According to a preferred embodiment, the release device 8 is fastened to saddle 2 and preferably comprises a discharge valve 8 suitable for discharging gas (e.g. air) from the inflatable member 6, for example by means of a discharge opening 81 of valve 8 which communicates with the undersaddle compartment 3 or with the outside of motorcycle 1 or of the undersaddle compartment 3.

According to a convenient embodiment, assembly 2, 3, 4 comprises a lock (not depicted), in itself known, which is operable for example, by means of a respective key, to allow opening saddle 2 from the closed configuration. According to a convenient embodiment, the object blocking system 4 comprises a control system operatively connected to the lock and to the release device 8 to control the release device 8 so as to allow the deflation of the inflatable member 6 by operating the aforesaid lock. Such a control system (not depicted in FIGS. 1 to 3 but identical to the control system which is described below with reference to the embodiment illustrated in FIGS. 7 to 9) may be made for example and not exhaustively, by means of a simple mechanical control. For example, such a control system may comprise a linkage of known type which is operable by means of the lock to allow saddle 2 to be released and accordingly to allow the latter to take on the open configuration. Conveniently, such a linkage may be operatively connected to the discharge valve 8 so that when saddle 2 is in the closed configuration and the related lock is closed, the discharge valve 8 takes on a closed status in which the aforesaid linkage closes, preferably by means of a mechanical connection, the discharge opening 81 so as to prevent the discharge of the air which keeps the inflatable member 6 in the expanded configuration. The operation of the aforesaid linkage by means of the lock of saddle 2 allows both opening saddle 2 and causing the discharge valve 8 to take on a release status in which the aforesaid linkage frees the discharge opening 81, preferably by means of the aforesaid mechanical connection, thus allowing the discharge of the air and accordingly, the deflation of the inflatable member 6 or expandable member 6. It is worth noting that when saddle 2 takes on the open configuration, the discharge valve 8 remains in the release status and the inflatable member 6 continues to deflate preferably up to reaching the resting configuration, in which the pressure of the air acting on the inflatable member 6 preferably reaches the atmospheric pressure. It is also worth noting in the example illustrated in FIGS. 1 to 3, that the inflatable member 6 cannot be inflated while the saddle is open, namely while the discharge valve 8 is in the release status. In other words, the release device 8 remains in a release status in which the inflatable member 6 cannot be inflated when the saddle 2 is in the open configuration. This condition follows from the fact that the saddle 2 couldn't be closed anymore with the inflatable member 6 inflated and therefore the vehicle would be unusable. To proceed with inflating the inflatable member 6, saddle 2 is to take on the closed configuration and the discharge opening 81 of the discharge valve 8 is to be closed again by the linkage of saddle 2.

Having described the structure of motorcycle 1, now there is described an operating example of the object blocking system 4 with reference to the embodiment illustrated in FIGS. 1 to 3.

With reference for example, to the case in which motorcycle 1 is operating, the jolts and related movements of the driver in saddle 2 act on the air pump 7 which slowly inflates membrane 6 up to causing it to occupy a significant part of the undersaddle compartment 3, and more preferably the maximum volume possible inside the undersaddle compartment 3, compatibly with the presence of object 5 and any further objects accommodated in compartment 3.

Once inflated, membrane 6 keeps object 5 and any further objects in contact with the bottom wall 31, thus preventing them from jumping around, bumping against each other and hitting the walls 31, 32 and/or saddle plate.

The control valve, when provided, lets the excess air out of space 25, thus keeping the pressure generated by membrane 6 constant on the objects in compartment 3 and keeping such objects stationary against the bottom wall 31.

When saddle 2 is opened by means of the specific lock, the release device 8 is operated by means of the aforesaid control system and membrane 6 is deflated, thus taking on the resting configuration again.

By closing saddle 2 again, the release device 8 closes again so that when the driver sits on saddle 2 again Sand motorcycle 1 is operating, membrane 6 resumes inflation up to taking on the expanded configuration again, in which it allows the objects in the undersaddle compartment 3 to be kept blocked.

With reference now to FIGS. 4 to 6, such drawings show a motorcycle according to a second embodiment, which is indicated as a whole with numeral 100. Motorcycle 100 comprises an assembly 2, 3, 104. Assembly 2, 3, 104 differs from assembly 2, 3, 4 of motorcycle 1 essentially in that it comprises an object blocking system 104 according to a second embodiment. As can be noted in FIGS. 4 to 6, the object blocking system 104 differs from the object blocking system 4 in FIGS. 1 to 3 essentially in that it comprises a different inflatable member 106 or expandable member 106. The inflatable member 106 is a blocking member provided to block object 5 accommodated in the container body 31, 32. In particular, the inflatable member 106 comprises a bellows member 106 fastened to the second face 22 of saddle rather than the elastic membrane 6 provided in the object blocking system 4. The bellows member 106 offers a flatter and more regular resting surface 163 with respect to the solution with the elastic membrane 6 on an object contained inside compartment 3. For example, the bellows member 106 may be fastened to face 22 of saddle by means of one or more brackets 161. In the example illustrated in FIGS. 4 to 6, the check valve 75 of the air pump 7 is connected to the bellows member 106 by means of a delivery duct 76, while the release device 8 is connected to the bellows member 106 by means of a discharge member duct 82. According to a preferred embodiment, the object blocking system 104 comprises an elastic return element 162 connected to saddle 2 and to the bellows member 106 to switch the bellows member 106 from the expanded configuration (FIG. 5 or depiction with dotted lines in FIG. 6) to the resting configuration (FIG. 4 or depiction with solid lines in FIG. 6).

According to a preferred embodiment, assembly 2, 3, 104 comprises a lock (not depicted), in itself known, which is operable to allow opening saddle 2 from the closed configuration (FIGS. 7 to 9). According to a convenient embodiment, the object blocking system 104 comprises a control system. Such a control system is operatively connected to the lock and to the release device 8 to control the release device 8 so as to allow the deflation of the inflatable member 106 by operating the aforesaid lock. According to a preferred embodiment, such a control system is identical to the control system described above with reference to the object blocking system 4 in FIGS. 1 to 3.

The operation of the object blocking system 104, mutatis mutandis, essentially is identical to the object blocking system 4 in FIGS. 1 to 3 and for brevity of description, is therefore not further described in detail.

With reference now to FIGS. 7 to 9, such drawings diagrammatically show an assembly 2, 3, 204 for a motorcycle according to a third, currently preferred embodiment. It is worth noting that even if a motorcycle is not shown in FIGS. 7 to 9, for the purposes of the present description also a motorcycle comprising assembly 2, 3, 204 is also implicitly considered to be described. Assembly 2, 3, 204 differs from assembly 2, 3, 4 in figure essentially in that it comprises an object blocking system 204 according to a third embodiment. As can be noted in FIGS. 7 to 9, the object blocking system 204 differs from the object blocking system 4 in FIGS. 1 to 3 essentially in that it comprises an inflatable member 206 or expandable member 206 accommodated in the container body 31, 32 of the undersaddle compartment 3 and preferably fastened to such a container body 31, 32. The inflatable member 206 is a blocking member provided to block an object 205 accommodated in the container body 31, 32. According to one embodiment, the inflatable member 206 comprises a annular member 206. The annular member 206 (depicted in cross section in FIGS. 7 to 9) is a member essentially shaped like a ring or an annular air chamber preferably Shaving a toroidal or partly toroidal shape. The fact of providing an annular inflatable member has various advantages: it allows the volume to be reduced when it is deflated; it allows a simple assembly of the same on the walls of the container body of the undersaddle compartment; it does not counter the action of the saddle plate; it is particularly suitable for keeping stationary semi-spherical objects such as helmets by gripping them along the perimeter thereof and making them integral with the fixed part of the container body of the undersaddle compartment. According to a preferred embodiment, a pressure control valve 391, in itself known, may be associated with the inflatable member 206. According to a preferred embodiment, such an annular member 206 is arranged with the respective middle opening 262 facing the bottom wall 31 of the container body 31, 32. Preferably, the inflatable member 206 is fastened to at least one of the walls 31 and 32 of body 31, 32.

The object blocking system 204 comprises an inflation device 207 operatively connected to the inflatable member 206 to allow the inflatable member 206 to be inflated. Preferably, the inflation device 207 comprises an electric pump 207, which preferably is provided with a check valve. Preferably, the electric pump 207 is controllable by means of controls provided on the dashboard of the motorcycle on which assembly 2, 3, 204 is intended to be installed. As shown for example in FIG. 1, the inflation device 207 preferably comprises a suction duct 271 for sucking the air, and a delivery duct 272 operatively connected to the inflatable member 206 to emit compressed air into such a member 206, and in particular into an air chamber 261 or gap 261 of member 206.

The object blocking system 204 comprises a release device 208, such as for example a discharge valve 208, operatively connected to the inflatable member 206 to allow the inflatable member 206 to be deflated. In FIG. 7, saddle 2 is in the closed configuration, the undersaddle compartment 3 is empty, i.e. it does not contain an object to be transported, and the inflatable member 206 is in a resting configuration in which it is deflated. In FIG. 8, saddle 2 is in the closed configuration, the undersaddle compartment 3 is empty and the inflatable member 206 is in an expanded configuration in which it is expanded with respect to the resting configuration. In particular, the inflatable member 206 is extended in the undersaddle compartment 3 in the expanded configuration, and is suitable for blocking object 205 accommodated in the undersaddle compartment 3. In FIG. 9, the inflatable member 206 is depicted in the expanded configuration while it blocks object 205, which in the example is not exhaustively a helmet 205. In particular, in the example in FIG. 9, the inflatable member 206 blocks helmet 205 against the bottom wall 31 of the container body. It is worth noting that according to a preferred embodiment, object 205 is received and retained inside the middle opening 262 of the inflatable member 206 in the expanded configuration of such a member 206. The inflation device 207 is suitable for switching the inflatable member 206 from the resting configuration (FIG. 7) to the expanded configuration (FIGS. 8 and 9). The release device 208 is suitable for switching the inflatable member 206 from the expanded configuration (FIGS. 8 and 9) to the resting configuration (FIG. 7).

According to a preferred embodiment, assembly 2, 3, 204 comprises a lock (not depicted), in itself known, which is operable to allow opening saddle 2 from the closed configuration (FIGS. 7 to 9). According to a convenient embodiment, the object blocking system 204 comprises a control system 209 (such a control system is depicted diagrammatically in FIGS. 7 to 9). The control system 209 is operatively connected to the lock and to the release device 208 to control the release device 208 so as to allow the deflation of the inflatable member 206 by operating the aforesaid lock. According to a preferred embodiment, the system 209 is identical to the control system described above with reference to the object blocking system 4 in FIGS. 1 to 3. In other words, according to one embodiment, the control system 209 comprises a linkage 291 of known type which is operable by means of the lock of saddle 2 to allow saddle 2 to be released and accordingly to allow the latter to take on the open configuration. Conveniently, such a linkage 291 may be operatively connected to the release device 208 so that when saddle 2 is in the closed configuration and the related lock is closed, the release device 208 takes on a closed status in which the aforesaid linkage 291 closes a discharge opening 281 of the release device 208, preferably by means of a mechanical connection 292, so as to prevent the discharge of the air which keeps the inflatable member 206 in the expanded configuration. The operation of the aforesaid linkage 291 by means of the lock of saddle 2 allows both opening saddle 2 and causing the release device 208 to take on a release status in which the aforesaid linkage 291 frees the discharge opening 281, thus allowing the discharge of the air and accordingly, the deflation of the inflatable member 206. It is worth noting that when saddle 2 takes on the open configuration, the release device 208 remains in the release status and the inflatable member 206 continues to deflate preferably up to reaching the resting configuration. The pressure of the air acting on the inflatable member 206 preferably reaches the atmospheric pressure. It is also worth noting in the example illustrated in FIGS. 7 to 9, that the inflatable member 206 cannot be inflated while saddle 2 is open. To proceed with inflating the inflatable member 206, saddle 2 has to take on the closed configuration and the discharge opening 281 of the release device 208 has to be closed again by means of the linkage 291 of saddle 2.

The operation of the object blocking system 204, mutatis mutandis, essentially is identical to the object blocking system 4 in FIGS. 1 to 3 and for brevity of description, is therefore not further described in detail. To this end, it is worth noting that although the inflation device 207 preferably comprises an electric pump 207, according to alternative embodiments, the inflation device 207 may comprise a different type of pump in place of an electric pump 207, operatively connected to the inflatable member 206, such as for example and not exhaustively, an air pump similar to the air pump 7 in FIGS. 1 to 3.

It is worth noting that although certain specific embodiments of the present invention were described above, several modifications and/or variants may be made with respect to that described above by mere way of example.

For example, it is worth noting that in general each of the above-described inflatable members, such as for example the inflatable members 6, 106, 206, may be fastened or coupled to at least one wall selected between the bottom wall 31 of the container body 31, 32, the side wall 32 of the container body 31, 32 or the second face 22 of saddle. For example, each of the inflatable members 6, 106, 206 could be coupled to the bottom wall 31 of the container body 31, 32 and/or to the side wall 32 of the container body 31, 32. In such a case, each of the above-described inflatable members could be fastened or coupled to the bottom wall 31 of the container body 31, 32 and be suitable for blocking an object accommodated in the container body 31, 32 in the expanded configuration against at least the second face 22 of saddle and possibly also against the side wall 32 of the container body 31, 32. In particular, it is worth noting that in general the inflatable member of an assembly comprising a saddle and an undersaddle compartment according to the present invention may be fastened to the second face 22 of saddle or accommodated in the container body 31, 32 so that in the expanded configuration, it is expanded with respect to the resting configuration so as to block an object accommodated in the container body 31, 32 against at least one between the bottom wall 31, the side wall 32 and the second face 22 of saddle when saddle 2 takes on said closed configuration.

According to that described above, it may be understood how an assembly comprising a saddle and an undersaddle compartment according to the present description allows the above-mentioned objects to be achieved with reference to the known art.

The principle of the invention being understood, the embodiments and manufacturing details may largely vary with respect to that described and illustrated by mere way of non-limiting example, without departing from the scope of the invention as defined in the appended claims.

1. An assembly comprising a saddle and an undersaddle compartment for a motorcycle, the undersaddle compartment comprises a container body, wherein the container body comprises an access opening, a bottom wall and a side wall joined perimetrally to the bottom wall, wherein the saddle comprises a first face shaped for a seat of a driver of the motorcycle and an opposite second face facing towards said undersaddle compartment, the saddle being operatively connected to the undersaddle compartment to take on an open configuration allowing access to the undersaddle compartment and to the container body by said access opening, and a closed configuration closing the undersaddle compartment, thus preventing access to the undersaddle compartment and to the container body,
said assembly comprising an object blocking system adapted to block an object accommodated in the container body of the undersaddle compartment, the object blocking system comprising:
an inflatable member fastened to the second face of the saddle, the inflatable member having:
a resting configuration, wherein said inflatable member is deflated and allows said object to be inserted into the container body by said access opening; and
an expanded configuration, wherein said inflatable member is expanded with respect to the resting configuration to block said object accommodated in the container body against at least one between said bottom wall, said side wall and said second face of the saddle when the saddle is in said closed configuration;
an inflation device operatively connected to the inflatable member for expanding the inflatable member from the resting configuration to the expanded configuration;
a release device operatively connected to the inflatable member for deflating said inflatable member to bring said inflatable member from the expanded configuration to the resting configuration;
wherein the release device remains in a release status in which the inflatable member cannot be inflated when the saddle is in the open configuration.

2. An assembly according to claim 1, wherein the inflatable member is fastened to the second face of the saddle for blocking said object against said bottom wall in said expanded configuration.

3. An assembly according to claim 1, wherein said inflation device comprises an air pump, the air pump comprising an air chamber, said air chamber communicating with the undersaddle compartment or with an outside of the undersaddle compartment to suck air inside said air chamber, said air chamber communicating with the inflatable member to allow inflation of the inflatable member, the air pump being operable by repeatedly pressing to compress said air chamber.

4. An assembly according to claim 1, wherein said air chamber is accommodated in said saddle so that said air chamber for inflating the inflatable member is compressed by repeatedly pressing on the first face of said saddle.

5. An assembly according to claim 1, wherein said inflatable member comprises an elastically deformable membrane fastened to the second face of the saddle to ensure gas tightness between said membrane and said second face of the saddle.

6. An assembly according to claim 1, wherein said inflatable member comprises a bellows member fastened to the second face of the saddle and wherein said object blocking system comprises an elastic return element connected to the saddle and to the bellows member to switch the bellows member from the expanded configuration to the resting configuration.

7. An assembly according to claim 1, comprising a lock allowing opening the saddle from the closed configuration, and wherein said object blocking system comprises a control system operatively connected to the lock and to the release device to control the release device to allow the deflation of the inflatable member by operating said lock.

8. An assembly according to claim 1, wherein said inflatable member comprises an annular member.

9. An assembly according to claim 8, wherein said inflatable member comprises a middle opening inside of which said object is received and retained in said expanded configuration.

10. A motorcycle comprising an assembly according to claim 1.
